(19) United States
(12) Patent Application Publication
(10) Pub. No.: US 2017/0043906 A1
(43) Pub. Date: Feb. 16, 2017

(54) DUAL-COMPARTMENT COOLER

(71) Applicant: Charles Ravenscraft, JR., Johnsburg, IL (US)

(72) Inventor: Charles Ravenscraft, JR., Johnsburg, IL (US)

(21) Appl. No.: 14/824,277

(22) Filed: Aug. 12, 2015

(51) Int. Cl. B65D 25/04; B65D 81/18; B62B 1/10; B65D 25/28

(52) U.S. Cl. CPC B65D 25/04; B65D 25/28; B65D 81/18; B62B 1/10

(57) ABSTRACT

A dual compartment cooler that includes: a cuboid container; a first lid, where the first lid covers a first compartment; a second lid, where the second lid covers a second compartment; and at least one handle. The first compartment stores items for cooling purposes and the second compartment stores waste. The dual compartment cooler may also include a net integrated into opposing sides of the cuboid container and a set of wheels.

### BACKGROUND OF THE INVENTION

Field of Invention

The present invention relates to a dual-compartment cooler that provides separate compartments for food and beverages and an alternative compartment for waste and trash.

Description of Related Art

Many individuals use portable coolers to transport food and beverages for outdoor consumption or on the go. The typical cooler is a rectangular insulated compartment that includes a lid and typically includes handles. The cooler may also have wheels or other accessories to assist in transporting the cooler. Within the main compartment individuals usually store food and beverages that need to be and preferably are stored cool. The insulated walls and lid of the cooler helps to maintain a cool environment and therefore keep the food and beverages cool. One consistent problem with portable coolers is the waste that is usually generated due to the consumption of the food and beverages. The waste usually necessitates that the user to further transport a waste container or bag to store waste in. As a result, it would be advantageous to have a cooler that includes a trash compartment so that individuals may have a separate compartment to discard waste and trash all within one container.

### SUMMARY OF THE INVENTION

The present invention relates to a dual compartment cooler that includes: a cuboid container; a first lid, where the first lid covers a first compartment; a second lid, where the second lid covers a second compartment; and at least one handle. The first compartment stores items for cooling purposes and the second compartment stores waste. The dual compartment cooler may also include a net integrated into opposing sides of the cuboid container and a set of wheels.

### BRIEF DESCRIPTION OF DRAWINGS

FIG. 1 provides a perspective view of a dual-compartment cooler in accordance with the present invention.

### DETAILED DESCRIPTION

The present invention relates to a dual-compartment portable cooler that includes a main compartment for storage of food and beverages and a second compartment to discard waste. The present invention further includes a storage net integrated on the opposing side panels of the cooler to provide additional storage area for other items. Further accessories associated with the present invention include wheels and a collapsible handle that allow for an individual to easily transport the cooler over a surface.

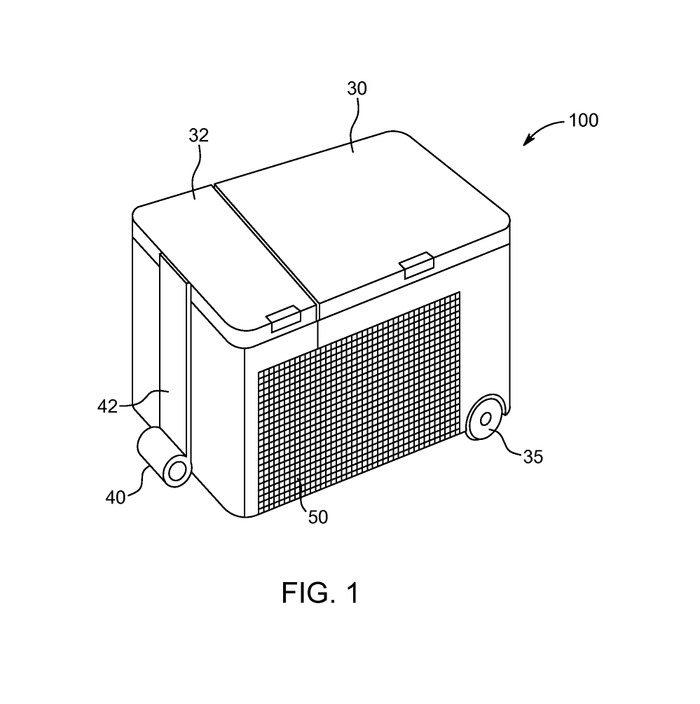

In reference to FIG. 1, a dual-compartment cooler 100 is depicted. This dual-compartment cooler 100 includes a cooler compartment under the cooler lid 30. Further a waste or trash compartment is provided under the trash lid 32. The cooler 100 further includes a storage net 50 integrated into opposing sides of the cooler 100. This storage net 50 allows an individual to place other items such as bug spray, paper towels, paper plates, or other items that may be needed while using the cooler 100.

Other features of the cooler 100 include a collapsible handle 40 that has a stem 42 extending from the cooler 100. This collapsible handle 40 may be extended and used in conjunction with wheels 35 shown in FIG. 1. The wheels 35 allow for the transporting of the cooler 100 over a smooth surface. The present invention as a result enables the user to have a cooler plus a trash container in one unit for use as needed. The instant invention has been shown and described in what it considers to be the most practical and preferred embodiments. It is recognized, however, that departures may be made there from within the scope of the invention and that obvious modifications will occur to a person skilled in the art.

1. A dual compartment cooler comprising:
a. a cuboid container;
b. a first lid, where the first lid covers a first compartment;
c. a second lid, where the second lid covers a second compartment; and
d. at least one handle; and
e. a net integrated into opposing sides of the cuboid container.

2. The dual compartment cooler according to claim 1, where the first compartment stores items for cooling purposes and the second compartment stores waste.

3. (canceled)

4. The dual compartment cooler according to claim 1, further including a set of wheels.
